(19) United States
(12) Patent Application Publication
(10) Pub. No.: US 2002/0024539 A1
(43) Pub. Date: Feb. 28, 2002

(54) System and method for content-specific graphical user interfaces

(75) Inventors: Alexandros Eleftheriadis, New York, NY (US); Harikrishna Kalva, New York, NY (US); Marios Athineos, New York, NY (US)

Correspondence Address: BAKER BOTTS L.L.P., 44TH FLOOR, 30 ROCKEFELLER PLAZA, NEW YORK, NY, 10112-4498, US

(73) Assignee: COLUMBIA UNIVERSITY

(21) Appl. No.: 09/850,914

(22) Filed: May 8, 2001

Related U.S. Application Data
(60) Provisional application No. 60/202,675, filed on May 8, 2000.

(51) Int. Cl. G06F 3/00

(52) U.S. Cl. 345/765

(57) ABSTRACT

This invention enables content-based GUI modification. The invention allows a new way of packaging elements of the GUI together with the application content to enable only the GUI necessary to present the received content. The packaged elements are then transmitted together with such content.

### CROSS-REFERENCES TO RELATED APPLICATIONS

This application is based on Provisional Application Ser. No. 60/202,675, filed May 8, 2000, which is incorporated herein by reference for all purposes and from which priority is claimed.

### SPECIFICATION

### BACKGROUND OF INVENTION

1. Field of the Invention

The present invention relates to graphical user interfaces. In particular, it relates to structures that enable software applications to use content-specific graphical user interfaces.

2. Description of the Related Art

In recent years, software applications have become increasingly complex. The applications often use data from different sources and of different character and perform many different tasks. Graphical user interfaces have emerged as a convenient mechanism to enable users to interact with such software applications.

A graphical user interface (“GUI”) is a software which allows users to interact with underlying software applications. A typical GUI provides windows and/or dialog boxes that enable a user to initiate an operation by an underlying computer program on the user's computer. The nature of interaction between a user and a particular application depends on both the software application that is used and the data content. For example, the user of a word-processing program may interact with the program by opening, editing, and saving the files. The user of a software program that plays video files may interact with the program by selecting files, playing them, forwarding video and pausing playback. Hence, interaction is both application-specific and content-specific.

However, this type of GUI design suffers from several significant problems. Specifically, GUI programs are ordinarily provided in standard packages with specific predetermined operations. In other words, a user is not able to customize and/or extend the GUI by editing it so as to add or remove specific operations that the user desired or did not desire. Moreover, since the programs are provided in standard packages, each time an upgrade is made to the program, the user must install the upgrade on the network or computer hosting the program.

Since different users may have different preferences with respect to how to use a particular application, it is desirable to allow users to customize a graphical user interface through which they interact with the software application. There have been attempts to provide a graphical user interface that can be user modified.

For example, WinAmp, an MP3 audio player, is an application that allows user GUI customization. GUI windows are ordinarily referred to as “skins.” Multiple skins are downloaded, and stored on the user's computer. The user is then afforded an opportunity to customize the appearance of the application's default GUI by loading one of the available skins. Loading a skin usually changes the appearance without affecting the functionality of the application's interface, although it is also possible to have skins that affect the functionality of the interface (e.g., skin that disables the pause button of an MP3 player).

FreeAmp is another MP3 audio player that allows GUI customization. As with Winamp, various skins are initially loaded on the user's computer, and then the user is afforded an opportunity to customize the appearance of the application's GUI. Unlike WinAmp, however, FreeAmp themes are not limited to having one layout for the controls. The FreeAmp window can accept shape information and the button layouts can take various desired forms. FreeAmp also allows users to leave out some buttons. FreeAmp uses an extensible mark-up language (XML) format to describe ‘skins’.

While these applications permit the customization of a graphical user interface typically by loading a custom-made GUI into a software application, they suffer from a common drawback in that they do not allow content-providers to package the elements of the GUI along with the content in order to allow the content-specific modifications to the GUI.

Accordingly, there remains a need for a GUI which permits content-specific customization.

### SUMMARY OF THE INVENTION

An object of the present invention is to provide a GUI which is adapted to the packaging of GUI elements along with content.

Another object of the present invention is to provide a GUI which enables content providers to deliver content-specific GUIs with transmitted content.

Yet another object of the present invention is to provide a GUI which may be changed based on the application content.

Still another object of the present invention is to eliminate the need for separately downloading customized GUIs.

In order to meet these and other objects which will become apparent with reference to further disclosure set forth below, the present invention provides a system and method for enabling content-based GUI modification. It further provides a novel way of packaging elements of graphical user interfaces together with the content that is transmitted to users, thus enabling content-creators to dynamically change and customize GUIs.

In preferred arrangements, GUI elements are packaged with the content to be transmitted to users. The GUI elements may be described in terms of their layout and interaction behavior. In yet another embodiment, the GUI may be dynamically changed during content transmission.

The accompanying drawings, which are incorporated and constitute part of this disclosure, illustrate an exemplary embodiment of the invention and serve to explain the principles of the invention.

### BRIEF DESCRIPTION OF THE DRAWINGS

FIG. 1 is an illustrative diagram showing the association between various content nodes and corresponding scene and object descriptors in an MPEG-4 System.

FIG. 2 is a schematic diagram of a simple Graphical User Interface in accordance with the present invention.

FIG. 3 is a schematic diagram of a GUI Bitmap with exemplary buttons.

FIG. 4, is a functional diagram of a system adapted to carry out the method of FIG. 3.

### DETAILED DESCRIPTION OF THE DRAWINGS

An exemplary embodiment of the present invention is described herein using an MPEG-4 standard system. MPEG-4 is an international standard for the object-based representation of multi-media content, and allows creation of multi-media content with multiple audio, video, image, and text elements. The MPEG-4 Systems standard specifies the technology for on-screen layout, packaging, and playing back mixed media components, and includes an extensible framework for customizing MPEG-4 applications. The capability of MPEG-4 to treat all elements of a multi-media program as individual objects allows for innovative ways of using downloadable and content-specific GUIs.

While the instant application will be described with respect to an MPEG-4 system, it should be noted that the invention described herein applies with equal force to other multi-media description schemes. For example, the QuickTIme fileformat can be used to package skins with content. Similarly, ASF file format, can be used. A text processing format can also be used since they are capable of handling different objects.

As those skilled in the art will appreciate, MPEG-4 specifies tools to encode individual objects, compose presentations with objects, store these object-based presentations and access these presentations in a distributed manner over networks; it thus provides a “glue” that binds audio-visual objects in a presentation. A basis for the MPEG-4 System architecture is a separation of media and data streams from their scene and object descriptors. A scene descriptor, also referred to as BIFS (Binary Format for Scenes), describes the scene, namely, where the particular elements are positioned in the skin and how they are related to each other. The scene is described in terms of its composition and evolution over time, and includes a scene composition and a scene update information. Object descriptors (OD) describe the data and media streams in a presentation. A description contains a sequence of object descriptors, which encapsulate the stream properties such as scalability, quality of service (QoS) required to deliver the stream, and the decoders and buffers required to process the stream. The object descriptor framework is an extensible framework that allows separation of an object and the object's properties.

This separation allows for providing different Quality of Service (QOS) for different streams. For example, scene descriptors have very low or no loss tolerance and need high QOS, whereas the associated media streams are usually loss tolerant and need lower QOS. These individual streams representing object descriptors, scene description and media are referred to as elementary streams at the system level.

An elementary stream in an MPEG-4 System is composed of a sequence of access units and is carried across the Systems layer as a set of sync-layer (SL) packetized access units. The sync-layer is configurable and a configuration for a specific elementary stream is specified in a corresponding elementary stream descriptor. The sync layer contains the information necessary for inter-media synchronization. The sync-layer configuration indicates a mechanism used to synchronize the objects in a presentation by indicating the use of time stamps or implicit media specific timing. Unlike MPEG-2, MPEG-4 Systems do not specify a single clock speed for the elementary streams. Each stream in an MPEG-4 presentation can potentially have a different clock speed. This puts additional burden on a terminal, as it now has to support recovery of multiple clocks.

In addition to the scene descriptors and object descriptors, an MPEG-4 session can also contain an Intellectual Property Management and Protection (IPMP) stream to protect media streams, an Object Content Information (OCI) stream that describes contents of the presentation, and a clock reference stream. All data that flows between a client and a server are SL-packetized.

The data communicated to the user from a server includes at least one scene descriptor. The scene descriptor, as the name indicates, carries the information that specifies the spatio-temporal composition of objects in a scene. In other words, the scene descriptors carry the information that shows how the multi-media objects are positioned on the screen and how they are spatio-temporally related to each other. The MPEG-4 scene descriptor is based on the Virtual Reality Modelling Language (VRML) specification. The scene is represented as a graph with media objects represented by the leaf nodes. The elementary streams carrying media data are bound to these leaf nodes by means of BIFS URLs. The URLs can either point to object descriptors in the object descriptor stream or media data directly at the specified URL. The intermediate nodes in the scene graph correspond to functions such as transformations, grouping, sensors, and interpolators. The VRML-event model adopted by MPEG-4 systems has a mechanism called ROUTEs that propagates events in the scene. This event model allows nodes such as sensors and interpolators to be connected to audio-visual nodes to create effects such as animation. This mechanism, however, is limited to the scene; there are no routes from a server to a client to propagate user events to a server. One way of establishing the routes from the server to the client is to specify an architecture that enables a propagation of user events to the server. This architecture may be adapted to fit tightly in a scene graph by encapsulating the server command functionality in a node called Command Node. In addition to VRML functionality, MPEG-4 includes features to perform server interaction, polling terminal capability, binary encoding of scenes, animation, and dynamic scene updates. MPEG-4 is also specifies a Java interface to access a scene graph from an applet. A Java applet included in an MPEG-4 presentation can be used to monitor user interaction with the presentation and generate responses to the events. The generated responses can be customized for each user. The ability to include programmable elements such as Java applets makes MPEG-4 content highly interactive with functionality similar to that of application programs. Further details of MPEG-4 are contained in ISO document ISO/IEC/SC29/WG11, Generic Coding of Moving Pictures and Associated Audio (MPEG-4 Systems)—ISO/IEC 14386-1, International Standards Organization, April 1999, the contents of which are incorporated by reference herein.

FIG. 1 shows the relationship between different streams in an MPEG-4 system. Each stream is represented by a circle encapsulating various components representing that stream. For example, multi-media content may consist of audio, video and image objects. Each of these objects is represented by a set of elementary streams for image 102, video 104 and audio 106, and a corresponding association of description streams, namely, scene graph description 150 and object description 130.

A scene graph description stream 150 may have several media nodes: a group node (G) 152, a transform node (T) 154, an image node (I) 156, an audio node (A) 158, and a video node (V) 159. The media nodes in the scene graph are associated with the media objects by means of object IDs (OD ID) 160.

Object description stream 130 of the multi-media scene carries various object descriptors, such as object descriptors for image 132, video 134 and audio 136. Each object descriptor in the object description stream 130 may include one or more elementary stream descriptors (not shown). A purpose of the object description framework is to identify and describe the properties of objects and to associate them appropriately to a multi-media scene. Object descriptors serve to gain access to MPEG-4 content. Object content information and the interface to intellectual property management and protection systems also may be part of this framework.

An object description stream 130 is a collection of one or more object descriptors that provide configuration and other information for the elementary streams 102, 104 and 106 that relate to either a multi-media object or a scene. Each object descriptor is assigned an identifier (object descriptor ID 160), which is unique within a defined name scope. This identifier (ODID 160) is used to associate each multi-media object in the scene graph description stream 150 with the corresponding object descriptor, and thus the elementary streams related to that particular multi-media object. For example, ODID is used to associate audio from the scene graph with ODA 136 and thus with ESA 106.

An exemplary syntax and semantics of an object descriptor in a conventional MPEG-4 System is given below:

class ObjectDescriptor extends ObjectDescriptorBase : bit(8) tag=ObjectDescrTag
{
bit(10) ObjectDescriptorID;
bit(1) URL_Flag;
const bit(5) reserved-0b1111.1;
if (URL_Flag) {
bit(8) URLlength;
bit( 8) URLstring [URLlength];
} else {
ES_Descriptor esDescr [1 .. 255];
OCI_Descriptor ociDescr[0 .. 255];
IPMP_DescriptorPointer ipmpDescrPtr[0 .. 255];
}
ExtensionDescriptor extDescr[0 .. 255];
}

The ObjectDescriptor class consists of three different parts. A first part uniquely labels the object descriptor within its name scope by means of an objectDescriptorId. Nodes in the scene description use objectDescriptorID to refer to the related object descriptor. An optional URLstring indicates that the actual object descriptor resides at a remote location.

A second part consists of a list of ES_Descriptors, each providing parameters for a single elementary as well as an optional set of object content information descriptors and pointers to IPMP descriptors for the contents for elementary stream content described in this object descriptor.

A third part is a set of optional descriptors that support the inclusion of future extensions as well as the transport of private data in a backward compatible way.

This exemplary syntax and semantics of an object descriptor contains an ObjectDescriptorID syntax element. This syntax element uniquely identifies the ObjectDescriptor within its name scope. The value 0 is forbidden and the value 1023 is reserved. URL_Flag is a flag that indicates the presence of a URLstring and URLlength is a length of the subsequent URLstring in bytes.

URLstring [ ] is a string with a UTF-8 encoded URL that points to another ObjectDescriptor. Only the content of this object descriptor shall be returned by the delivery entity upon access to this URL. Within the current name scope, the new object descriptor shall be referenced by the objectDescriptorID of the object descriptor carrying the URLstring. Permissible URLs may be constrained by profile and levels as well as by specific delivery layers.

Since the exemplary signal consists of audio, video and image objects, the object descriptors have corresponding elementary stream descriptors. For example, an image object descriptor has an image elementary stream descriptor, a video object descriptor has a video elementary stream descriptor, etc. The elementary streams for these objects 102, 104 and 106 with various components are packetized and carried in separate channels, and transmitted to the user as a set of components. Alternatively, they may be stored as separate tracks in an MP4 file.

Elementary stream descriptors include information about the source of the stream data, in form of a unique numeric identifier (the elementary stream ID 170) or a URL pointing to a remote source for the stream. Elementary stream descriptors also include information about the encoding format, configuration information for the decoding process and the sync layer packetization, as well as quality of service requirements for the transmission of the stream and intellectual property identification. Dependencies between streams can also be signaled within the elementary stream descriptors. This functionality may be used, for example, in scalable audio or visual object representations to indicate the logical dependency of a stream containing enhancement information, to a stream containing the base information. It can also be used to describe alternative representations for the same content (e.g. the same speech content in various languages).

In the present invention, the GUI elements (the associated graphics and descriptions) are packaged in a file format used to store multi-media content. For example, the GUI elements may be packaged according to a MPEG-4 Systems standard. The GUI components and the GUI layout description are typically packaged as separate objects and identified as GUI elements using the object identification mechanism of the file format or the streaming format. In the present example, encoding of the descriptors and the images is done according to the MPEG-4 Systems standard. The description and layout of the GUI are a part of the scene description and object description streams. These streams and the images for the buttons are, in turn, a part of the MPEG-4 content. The GUI layout is encoded as a GUI extension descriptor in an initial object descriptor or in subsequent object descriptor updates. The graphical elements are included in the content as separate objects.

When content is downloaded, the application downloads (or reads from a local file) the GUI elements and activates the application GUI before loading the presentation. In the example described herein, the MPEG-4 application downloads the GUI elements and activates the application GUI. The initial object description contains a GUI_Descriptor and an ESDescriptor for the GUI bitmaps. The application enables only the buttons as described in the GUI_Descriptor. During a presentation, additional buttons may be enabled or disabled using GUI descriptor updates.

GUI descriptor updates allow the GUI to be changed dynamically during the presentation. A GUI descriptor update is transmitted to a client using an object descriptor update. If the application already has an existing GUI, it is replaced by a GUI descriptor update that is received by the application. Alternatively, if the application does not have a current GUI descriptor, a GUI descriptor update is loaded in the presentation. Whenever a GUI descriptor update is received, the application GUI is also updated accordingly. If the GUI elements are not included in the content, applications can use their default GUI or download a default GUI according to user preferences.

Extension Descriptors are used to extend the object descriptors to carry GUI specific information. A GUI extension descriptor describes the elements of the GUI in terms of their layout and interaction behavior. The GUI extention descriptor can describe an application GUI or a content GUI.

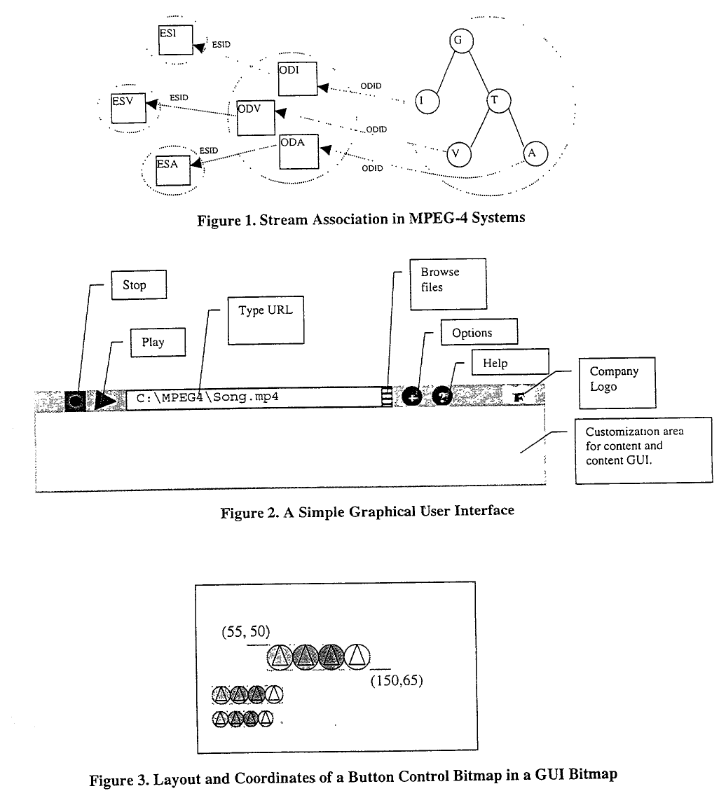

An application GUI determines the appearance of the application itself, i.e., the buttons, their positions, and behavior. FIG. 2 shows an exemplary application GUI. The application GUI window contains a content-display area, where any content-specific interaction elements are placed. The GUI descriptors are always located in object descriptors which contain at least one ES descriptor that describes the bitmap or image used for the buttons in the GUI. An exemplary syntax and semantics of an Extension descriptor in a MPEG-4 System are given below:

class GUI_Descriptor extends ExtensionDescriptor : bit(8) tag = 0×AA {

// Registration descriptor to uniquely identify the descriptor
RegistrationDescriptor rd;
// content GUI or application GUI
bit (8) guiType;
if (guiType == 0) {

while (bit (16) button_id != 0);

unsigned int (16) position [2];
unsigned int (16) bitmap_rect [4];
unsigned int (8) transparent_color [3];

}

} else if (guiType == 2) {

unsigned int (16) data_lenght;
char [data_length] guiXMLDescription;

}

The registration descriptor “rd” uniquely identifies the GUI descriptor, and may be obtained from the ISO-sanctioned registration authority. A “guiType” identifies the GUI described by the descriptor. The guiType of 0 indicates that the GUI is described using a binary description. The guiType of 2 indicates that the GUI is described using an XML description.

A button_id command uniquely identifies the type/behavior of the button. A sample list of button descriptions and IDs used in MPEG-4 systems is given below:

TABLE 1
List of basic buttons and button IDs

| Button | | Button |
|---|---|---|
| Name | Description | ID |
| Play | The play button that gets disabled during playback | 0 × 01 |
| Pause | The pause button that gets disabled during non | 0 × 02 |
| | playback | |
| Stop | stop playing | 0 × 03 |
| Prev | go to previous track | 0 × 04 |
| Next | go to next track | 0 × 05 |
| Quit | quit the player | 0 × 06 |
| Options | open options dialog | 0 × 08 |
| Minimize | Minimizes the application | 0 × 09 |
| Help | Show the FreeAmp help files | 0 × 0A |
| Files | Allows the user to select a file to play | 0 × 0B |
| Browser | Open browser with application home page | 0 × 0C |
| AppBar | Background for the application bar Position ignored | 0 × 0D |

XML provides a flexible framework to describe a GUI. Textual descriptions are also easier to use and write. An XML schema with elements used to describe a rich graphical user interfaces is described below. The images, bitmaps, and fonts representing the sources of GUI elements are packaged along with other objects in an MPEG-4 presentation. The object IDs of these images and bitmaps are also part of the XML description. The XML GUI description is encoded in the GUI descriptor (guiType=2) and is stored in MP4 files as a part of the content. An MP4 file can have multiple GUI descriptions that delivered to the player at times specified by their timestamps in the MP4 files.

Several exemplary tags are provided below:

point

The point tag is used in many cases in a GUI description. It corresponds to the location of an individual pixel. The origin (0, 0) is positioned on the upper left corner of the GUI.

To specify a point:

<point x=“100” y=“200”/>

rect

A rect tag specifies a rectangular region on a bitmap. It is defined using two points, the upper left and the lower right (inclusive).

To specify a rect:

<rect>

<pt1 x=“100” y=“200”/>
<pt2 x=“100” y=“300”/>

</rect>

color

A color tag specifies the color used to either define transparencies or to render text. It points to the bitmap that contains the color we want to refer to by specifying the name of the bitmap and the point that contains the color. This technique was preferred over a standard html coloring scheme because of the assumption of a custom renderer on the client side.

To specify a color:

<color bitmapName=“MainImage”>

<pixe1 x=“0” y=“0”/>

</color>

font

A font tag specifies a font that can be used in a text control. The name attribute gives the font a name, which controls will refer back to. The file attribute allows the author to optionally embed his own true type font in the MPEG-4 file. The face attribute specifies the font to use.

To specify a font:

<font name=“MainFont” file=“Arial.ttf” face=“Arial”/>

(or)

<font name=“MainFont” face=“Arial”/>

format

A format tag specifies various attributes related to the appearance of a text control. The fontName attribute specifies which font to use. The alignment attribute can be Left, Right or Center. The scrolling, blinking, bold, italic and underline attributes can be either true or false. The color tag specifies the color of the text.

To specify a format:

<format fontName=“MainFont”

alignment=“Right”
scrolling=“true”
italic=“true”
>

<color name=“MainImage”>

<pixel x=“0” y=“0”/>

</color>

</format>

bitmap

A bitmap tag specifies a bitmap file to include in the MPEG-4 stream. The name attribute gives the bitmap a name, which controls will refer back to. It optionally includes a transparent color tag, the use of which allows arbitrary shaped windows and buttons. The association between file names and object IDs is established using ODID attributes.

To specify a bitmap:

<bitmap name=“Buttons”

file=“buttons.png”
odID=“1”>

<transColor>

<pixel x=“0” y=“0”/>

</transColor>

</bitmap>

sourceBitmap

A sourceBitmap tag specifies the name of the bitmap and the region on it that contains the graphics of a specific control (button, slider etc). Each control (button or slider) can have up to four different states, normal (no user action), pressed (after a user click), hover (when the mouse hovers over it) and disabled (doesn't permit any interaction). In most of the cases the normal and the pressed states are enough to support clicking. The region must contain images for the states the control wants to support. The order of the images must be Normal, Pressed, Hover and Disabled and the author is free to leave out any of the states.

To specify a sourceBitmap:

<sourceBitmap bitmapName=“Buttons”>

<rect>

<pt1 x=“0” y=“0”/>
<pt2 x=“100” y=“400”/>

</rect>

</ sourceBitmap>

buttonControl

A buttonControl tag specifies the look and behavior of a button. A button can correspond to one of a predetermined number of actions like Play, Stop etc. The name attribute establishes this association. The pressed, hover and disabled attributes can selectively disable the corresponding state of the button (by default enabled). The tooltip attribute specifies the text that is displayed when the user hovers the mouse over the control. The position tag specifies where the control is going to be placed on the GUI. The sourceBitmap tag specifies the look of the button.

To specify a buttonControl:

<buttonControl name=“Play”

hover=“false”
tooltip=“Start playing”
>

<position>

<pixel x=“100” y=“50”/>

</position>
<sourceBitmap name=“Buttons”>

<rect>

<pt1 x=“0” y=“0”/>
<pt2 x=“100” y=“400”/>

</rect>

</ sourceBitmap>

</buttonControl>

textControl

A textControl tag specifies the appearance of a text field. A text control corresponds to one of a predetermined number of text destinations like File Name, Album etc. The name attribute establishes this association. The tooltip attribute specifies the text that is displayed when the user hovers the mouse over the control. The boundingRect tag specifies where on the GUI the text is going to be rendered. The dimensions of the rectangle implicitly define the size of the font (there is no font size attribute). There is also a format and a color tag.

To specify a textControl:

<textControl name=“File Name” tooltip=“File Name”>

<boundingRect>

<pt1 x=“100” y=“200”/>
<pt2 x=“200” y=“220”/>

</boundingRect>
<format name=“MainFont”

alignment=“Right”
scrolling=“true”
italic=“true”
>

<color name=“MainImage”>

<pixel x=“1” y=“0”/>

</color>

</format>

</textControl>

sliderControl

A sliderControl tag specifies the position and the appearance a slider. A slider control corresponds to one of a predetermined number of controls like Volume etc. The name attribute establishes this association. The pressed, hover and disabled attributes can selectively disable the corresponding state of the slider (by default enabled). The tooltip attribute specifies the text that is displayed when the user hovers the mouse over the control. The boundingRect tag specifies where on the GUI the slider is going to be rendered. It implicitly specifies the orientation of the control (horizontal versus vertical). There is also a sourceBitmap tag.

To specify a sliderControl:

<sliderControl name=“Volume”

tooltip=“Adjusts the volume”
>

<boundingRect>

<pt1 x=“100” y=“200”/>
<pt2 x=“200” y=“220”/>

</boundingRect>
<sourceBitmap name=“Buttons”>

<rect>

<pt1 x=“0” y=“0”/>
<pt2 x=“100” y=“400”/>

</rect>

</sourceBitmap>
</sliderControl>

window

A window tag specifies the controls and the background image of a window. The name attribute gives the window a name, which controls will refer back to. The background tag specifies the look of the window. The rect tag in background implicitly specifies the size of the window. It can contain any number of controls like buttons text and sliders.

To specify a window:

<window name=“MainWindow”>
<background name=“Background”>

<rect>
<ptl x=“0” y=“0”/>
<pt2 x=“400” y=“200”/>
</rect>

</background>
<buttonControl name=“Play”

tooltip=“Starts playing”
>

. . .
</buttonControl>
. . .
<textControl name=“File Name” tooltip=“File Name”>
. . .
</textControl>
. . .
<sliderControl name=“Volume”

tooltip=“Adjusts the volume”
>

. . .
</SliderControl>
. . .
</window>

credits

A credits tag specifies information about the GUI author.

To specify credits:

| | |
|---|---|
| <credits | name=“Funky GUI” |
| | author=“Marios Athineos” |
| | email=“marios@flavorsoftware.com” |
| | webPage=“http://www.flavorsoftware.com” |
| | /> |

settings

A settings tag specifies general settings like the version of the description for correct parsing the scrolling rate (in milliseconds per character move) for scrolling text and the blinking rate (in milliseconds per blinking) for blinking text.

To specify settings:

| | |
|---|---|
| <settings | version=“1.00” |
| | scrollingRate=“1” |
| | blinkingRate=“1” |
| | > |

</settings>

contentGUI

A contentGUI tag contains all the hierarchy of tags. It contains a settings and a credits tag and any number of font, bitmap and window tags.

To specify contentGUI:

<contentGUI>
<settings version=“1.00”

scrollingRate=“1”
blinkingRate=“1”

>
</settings>
<credits name=”Funky GUI”

authom=“Marios Athineos”
email=“marios@flavorsoftware.com”
webPage=“http://www.flavorsoftware.com”

</credits>
<bitmap name=“Buttons”

file=“buttons.png”
odID=“1”>

<transColor>
<pixel x=“0” y=“0”/>
</transColor>
</bitmap>
<bitmap name=“Background”

file=“background.png”
odID=“2”>
<transColor>
<pixel x=“0” y=“0”/>
</transColor>
</bitmap>
<font name=“MainFont” face=“Arial”/>
<font name=“SecondaryFont” face=“Times New Roman”/>
<window name=“Main Window”>
. . .
</window>
<window name=“Playlist”>
. . .
</window>
</contentGUI>

A “position” command defines a position of the button on the application bar. The position is given as the coordinates for a top-left corner of each button rectangle. Position is ignored for the application bar background -AppBar (Table 1).

A bitmap is described using a “bitmap_rect” variable. The rectangle coordinates are given as four integers corresponding to the top-left and bottom-right corners of the button bitmap. Referring to FIG. 3, a layout and coordinates of a button control in a GUI bitmap is illustrated. The top left corner 310 is represented with two integer coordinates, and the lower right corner 320 is represented with additional two integer coordinates. The rectangle may contain four button bitmaps for four states of a button: Normal, MouseOver, Pressed, and Disabled. The ES Descriptor in the object descriptor is used to point to the bitmap.

A GUI in a software application used for playing multi-media content typically has buttons for opening files, playing, forwarding, rewinding, and stopping the playback. Referring again to FIG. 2, a GUI ordinarily has a variety of commonly used buttons which represent specific elements of the GUI. Hence, a STOP button 210, PLAY button 220, HELP button, and OPTIONS button 230 are all specific elements of the GUI. In addition to the buttons, browse windows, such as browse files 280, a TYPE URL window 240 and company logo box 250, are elements of the GUI. Each of these elements has a specific texture, color, shape and an associated image.

In order to create a content GUI, the GUI description is prepared first along with the graphics necessary for the GUI buttons. The GUI description and the graphics for the GUI are then packed with the multi-media presentation. In the present example, the GUI description and the GUI graphics are packaged with the MPEG-4 presentation. The GUI description is encoded using the GUI Descriptor located in the initial Object Descriptor, whereas the graphics for the GUI are added to the MPEG-4 content as separate elementary streams. Both, the initial Object Descriptor and the GUI graphics elementary streams are parts of the same MP4 file. If there is more than one content GUI for a particular content, the time stamps associated with the object descriptors and object descriptor updates are used to load the GUI at that time. The GUI elements transmitted with the content provide information relating to color, texture, and image used for each button.

The functionality of the GUI, i.e., what happens when a button is pressed, is specified using the MPEG-4 object descriptors and the scene description framework. The object descriptor of the Object Descriptor framework can be extended with a GUI_Descriptor class to identify the GUI elements. The extensions specify the application's behavior when a particular button is used, i.e., play mode when the associated PLAY button 220 is pressed.

The application GUI_Descriptor is typically included in the initial object descriptor. The initial object descriptor in that case has at least two ES descriptors corresponding to a scene descriptor and an image bitmap for the GUI elements, namely a GUI descriptor. The buttons are placed in the application window as described in the GUI descriptor. The interaction with the buttons and the resulting application behavior is handled by the application framework.

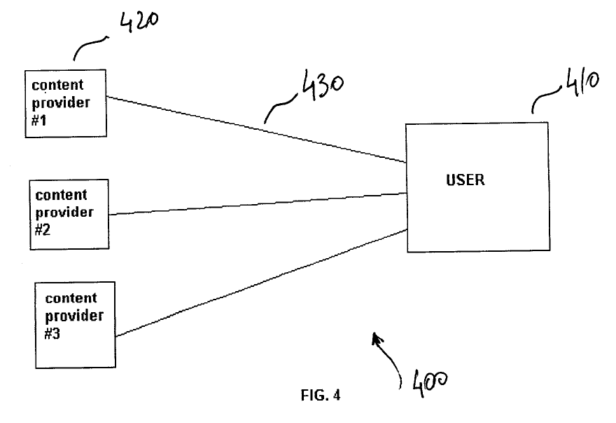

Referring to FIG. 4, an exemplary system 400 using the present invention is illustrated. A user 410 may be connected to a variety of content providers 420 by a network 430. The content providers 420 transmit content-specific GUIs along with multi-media content over the internet network 430. When the user 410 receives multi-media content, it also receives the associated content-specific GUIs that facilitate spatio-temporal presentation of the received content.

For example, an MPEG-4 player plays MP4 files on the user's computer. User 410 can download MP4 files from a server (e.g., web server) over a network, such as internet, and save MP4 files to a local computer. The user 410 can open and play the locally stored MP4 files. If an MP4 file contains a content-specific GUI as indicated by a GUI Descriptor, the MPEG-4 player loads such GUI.

The MPEG-4 player can also play MP4 files streamed to the user 410 by content providers 420 through MPEG-4 servers and the network 430. When the player is connected with a server, the player first receives an initial object descriptor for the MPEG-4 presentation. The initial object descriptor may contain the GUI descriptor in addition to the ES descriptors for the object description and scene descripton streams. The player first opens a channel to receive the object description stream from the server. The server then transmits the object descriptors necessary to create the scene. The player subsequently processes the GUI descriptor, opens the channels and receives the bitmaps/images refered in the GUI descriptor. Once all the GUI elements are received, the player loads the GUI according to the description. The player then opens the BIFS channel and processes the received Scene Description stream. The Processing of the Scene Description stream finally yields an MPEG-4 presentation.

When an MPEG-4 presentation is streamed to a player, the ES descriptors may have URLs that point to additional servers (servers other than the main server). The objects referred to in an MPEG-4 presentations may thus come from different servers, and consequently from different content providers 420.

It is important to note that content providers 420 and users 410 need not be connected by a network 430. Content providers 430 can provide users with multi-media content and the associated GUIs by submitting CDs, hard discs or other means of providing digital information to the user 410, which are then loaded by the software.

Exemplary software which may be provided in system 400 is attached hereto as Appendix A.

The foregoing merely illustrates the principles of the invention. Various modifications and alterations to the described embodiments will be apparent to those skilled in the art in view of the teachings herein. For example, in a preferred embodiment, an extensible mark-up language (XML) is used to define the GUI descriptors. It is to be appreciated that other programming languages can be used.

It is to be appreciated that other applications which have file formats (or streaming format) that allow identification of discrete objects can benefit from packaging and transmitting GUI with the content. For example, a QuickTIme and ASF file formats can be used to package and transmit skins with the content. Furthermore, text processing formats that allow inclusion of objects such as pictures and excel docs can be used to package and transmit skins with the content.

It will thus be appreciated that those skilled in the art will be able to devise numerous techniques which, although not explicitly shown or described herein, embody the principles of the invention and are thus within the spirit and scope of the invention.

We claim:

1. A method for generating a content specific graphical user interface comprising multimedia content and descriptions associated with said multimedia content, comprising the steps of:
(a) receiving said multimedia content;
(b) generating one or more graphical user interface descriptions associated with said received multimedia content for specifying one or more attributes of said graphical user interface; and
(c) packaging said generated descriptions with said multimedia content such that said generated descriptions are identifiable as one or more graphical user interface descriptions.

2. The method of claim 1, wherein said multimedia content comprises still images.

3. The method of claim 1, wherein said multimedia content comprises video.

4. The method of claim 1, wherein said one or more attributes of said graphical user interface are selected from the group consisting of spatial location, and intended response to user interaction.

5. The method of claim 4, wherein said one or more graphical user interface descriptions further include time information.

6. The method of claim 1, further comprising the step of transmitting said packaged descriptions and multimedia content to one or more users.

7. A system for generating a content specific graphical user interface comprising multimedia content and descriptions associated with said multimedia content, comprising:
(a) means for receiving said multimedia content;
(b) means, coupled to said receiving means, for generating one or more graphical user interface descriptions associated with said received multimedia content for specifying one or more attributes of said graphical user interface; and
(c) means, coupled to said generating means, for packaging said generated descriptions with said multimedia content such that said generated descriptions are identifiable as one or more graphical user interface descriptions.

8. The system of claim 7, wherein said multimedia content comprises still images.

9. The system of claim 7, wherein said multimedia content comprises video.

10. The system of claim 7, wherein said one or more attributes of said graphical user interface are selected from the group consisting of spatial location, and intended response to user interaction.

11. The system of claim 7, wherein said one or more graphical user interface descriptions further include time information.

12. The system of claim 7, further comprising a communications network, coupled to said packaging means, for transmitting said packaged descriptions and multimedia content to one or more users.

13. A method for presenting a content specific graphical user interface comprising multimedia content and descriptions associated with said multimedia content, comprising the steps of:
(a) receiving packages of multimedia content together with one or more embedded graphical user interface descriptions;
(b) identifying said one or more embedded graphical user interface descriptions;
(c) arranging one or more of said packages of multimedia content in accordance with said one or more embedded graphical user interface descriptions to generate a graphical user interface.

14. The method of claim 13, wherein said multimedia content comprises still images.

15. The method of claim 13, wherein said multimedia content comprises video.

16. The method of claim 13, wherein said one or more attributes of said graphical user interface are selected from the group consisting of spatial location, and intended response to user interaction.

17. The method of claim 16, wherein said one or more graphical user interface descriptions further include time information, and wherein said arranging step further comprising arranging one or more of said packages of multimedia content in accordance with said time information to generate a time dependant graphical user interface.

18. The method of claim 17, wherein said received packages of multimedia content and embedded graphical user interface descriptions are associated with two or more different graphical user interfaces, each having different time information, such that at least two different graphical user interfaces are generated at different times.
